(19) United States
(12) Patent Application Publication
(10) Pub. No.: US 2026/0352337 A1
(43) Pub. Date: Nov. 5, 2026

(54) COMMUNICATION SYSTEM AND CONTROL METHOD

(71) Applicant: NTT, Inc., Tokyo (JP)

(72) Inventors: Manabu YOSHINO, Musashino-shi, Tokyo (JP); Shin KANEKO, Musashino-shi, Tokyo (JP); Kazutaka HARA, Musashino-shi, Tokyo (JP); Junichi KANI, Musashino-shi, Tokyo (JP); Naotaka SHIBATA, Musashino-shi, Tokyo (JP)

(21) Appl. No.: 19/109,165

(22) PCT Filed: Sep. 7, 2022
(86) PCT No.: PCT/JP2022/033572

§ 371 Date: Mar. 6, 2025

(51) Int. Cl. H04B 10/291; H04J 14/02

(52) U.S. Cl. CPC H04B 10/291; H04J 14/02

(57) ABSTRACT

An aspect of the present invention includes: a multiplexer that multiplexes a signal input from a user terminal; a splitter that splits a signal addressed to a user terminal from a multiplexed signal; and a blocker of at least one of a multiplexing blocker that blocks a wavelength component other than a wavelength set to a user terminal in a signal input from a user terminal before or after multiplexing by the multiplexer is performed, or a splitting blocker that blocks a wavelength component other than a wavelength set to a user terminal in a signal addressed to a user terminal split by the splitter after or before splitting by the splitter is performed.

### TECHNICAL FIELD

The present invention relates to a technology of a communication system, and a control method.

### BACKGROUND ART

There is an innovative optical and wireless network (IOWN) that eliminates photoelectric conversion and electrical routing processing as much as possible. A user device in an all-photonics network (APN) of the IOWN illustrated in FIG. 8 performs communication using a wavelength and a route that are set to a photonic gateway (Ph-GW). The wavelength and the route set by the Ph-GW may be designated by, for example, an APN controller.

Exchange of a wavelength and route information is performed using, for example, a control signal channel said to be auxiliary management and control channel (AMCC) at the start of communication of the user device. At the start of communication, the user device communicates with a control functioner disposed in the Ph-GW and is connected to any communication destination.

The Ph-GW includes five functions. The first is a wavelength control/monitoring function of designating and controlling which wavelength is used by a user device and monitoring the wavelength of a signal. The second is a passing/stopping function of passing a signal in accordance with opening of a path and stopping an unnecessary signal. The third is a aggregation/disaggregation function of a function of aggregating optical signals having wavelengths set to respective user devices as necessary and transferring the optical signals to a relay network, and disaggregating optical signals transferred from the relay network for each of the wavelengths as necessary and transferring the optical signals to the user devices. The fourth is a turning function of enabling turning back at the Ph-GW to which an optical signal is input without transferring the optical signal to the relay network. The fifth is an extraction/insertion function for performing reproduction, relay, and electrical processing.

The Ph-GW can be regarded as a reconfigurable optical add-drop multiplexer (ROADM) including a function of controlling a remote transponder (TPND) and not including the TPND in itself, or a TPND aggregator (TPA, transponder aggregation switch) included in a ROADM including a function of controlling a remote TPND and not including the TPND in itself. Four structural examples of a ROADM will be described.

FIG. 9 is a diagram illustrating Configuration Example 1 of a ROADM or a part thereof. Configuration Example 1 includes an M*1 WSS 9012 having an M*1 configuration, a 1*N coupler/splitter 9021 having a 1*N configuration, an N*WSS 9010 having an N*1 configuration, and a 1*M WSS 9011 having a 1*M configuration. Note that a WSS is a wavelength selective switch.

The M*1 WSS 9012 receives as input signals on M paths from a user network interface (hereinafter, referred to as “UNI”) side. The M*1 WSS 9012 multiplexes the signals input from the UNI side according to the combination of an input port and a wavelength, and outputs the signals to the 1*N coupler/splitter 9021. The coupler/splitter 9021 splits the signals input from the M*1 WSS 9012 for N paths, and transmits the signals to the N paths on a network network interface (hereinafter, referred to as “NNI”) side.

The N*1 WSS 9010 receives as input signals on N paths from the NNI side. The N*1 WSS 9010 multiplexes the signals input from the NNI side according to the combination of an input port and a wavelength, and outputs the signals to the 1*M WSS 9011. The 1*M WSS 9011 outputs the signals from the N*1 WSS 9010 to M paths on the UNI side according to the wavelength.

Configuration Example 1 includes a Colorless function and a Directionless function, but does not include a Contentionless function. The Colorless function is a function of changing a combination of a wavelength (=Color) and a port such that a signal route inside a node is not restricted by a wavelength of a signal by providing a wavelength tunable function to a multiplexing-demultiplexing filter or the like. The Directionless function is a function of freely setting the direction of input/output paths of a transponder by a transponder aggregation switch configuration or the like in which two WSSs are connected so as to face each other. The Contentionless function is a function of avoiding collision of signals having the same wavelength inside a transponder aggregation switch connected to different paths by a WSS having an N*M configuration or the like in which a plurality of ports is included in each of input and output and any path is set among the plurality of ports.

FIG. 10 is a diagram illustrating Configuration Example 2. Configuration 2 is a configuration using two upper and lower multicast switches (MCSs). The first MCS of Configuration Example 2 includes M 1*N optical switches 9113 and N M*1 couplers/splitters 9111, and the other MCS includes N 1*M couplers/splitters 9112 and M N*1 optical switches 9114. In the first MCS, each of the 1*N optical switches 9113 receives as input a signal on one path from the UNI side. Each of the 1*N optical switches 9113 outputs the signal input from the UNI side to any of the M*1 couplers/splitters 9111. Each of the M*1 couplers/splitters 9111 multiplexes signals input from the 1*N optical switches 9113 and outputs the multiplexed signals to one path on the NNI side.

In the other MCS, each of the 1*M couplers/splitters 9112 receives as input a signal on one path from the NNI side. Each of the 1*M couplers/splitters 9112 splits the signal input from the NNI side and outputs the signals to the N*1 optical switches 9114. Each of the N*1 optical switches 9114 selects a signal from the 1*M couplers/splitters 9112 according to the input port, and outputs the signal to one path on the UNI side. Configuration Example 2 includes the Colorless function, the Directionless function, and the Contentionless function. In Configuration Example 2, an amplifier for compensating for losses of the MCSs due to the splitting is usually required.

FIG. 11 is a diagram illustrating Configuration Example 3. Configuration Example 3 includes an M*N WSS 9201 and an N*M WSS 9202. The M*N WSS 9201 receives as input signals on M paths from the UNI side. The M*N WSS 9201 outputs the signals input from the UNI side to any of N paths on the NNI side according to the combination of an input port and a wavelength. The N*M WSS 9202 receives as input signals on the N paths from the NNI side. The N*M WSS 9202 outputs the signals input from the NNI side to any of M paths on the UNI side according to the combination of an input port and a wavelength. Configuration Example 3 includes the Colorless function, the Directionless function, and the Contentionless function.

FIG. 12 is a diagram illustrating Configuration Example 4. Configuration Example 4 includes an M*N optical switch 9302, arrayed-waveguide gratings (AWGs) 9303, AWGs 9313, and an N*M optical switch 9312. The M*N optical switch 9302 receives as input signals on M paths from the UNI side. The M*N optical switch 9302 outputs the signals input from the UNI side to any port of any AWG 9303 according to the input port. Each of the AWGs 9303 multiplexes the signals input from the M*N optical switch 9302 according to the combination of an input port and a wavelength, and outputs the signals to the NNI side. Each of the AWGs 9313 outputs a signal input from the NNI side to any of N ports of the N*M optical switch 9312 according to the combination of an input port and a wavelength. The N*M optical switch 9312 outputs signals input from the AWGs 9313 to any of M paths on the UNI side according to the input port.

The Ph-GW can be configured using each of the above-described Configuration Examples 1 to 4 or a part thereof. The Ph-GW can be configured using a component having no wavelength selectivity such as an MCS.

### CITATION LIST

### Non Patent Literature

Non Patent Literature 1: “Novel System Architecture toward the Realization of All-photonics Network”, the Journal of Institute of Electronics, Information and Communication Engineers Vol.104 No.5 pp.471-477, 2021

Non Patent Literature 2: The Structures of ROADMhttps://optical-passive.com/2019/08/30/the-structures-of-roadm/

### SUMMARY OF INVENTION

### Technical Problem

In a Ph-GW, if a user terminal uses only a wavelength set by an APN controller, a signal needs to be transmitted, and if an unset inappropriate wavelength is used, a signal needs to be blocked. However, in configurations other than Configuration Example 4 that are a part of the configuration examples described above, there is an issue that a signal having an inappropriate wavelength cannot be blocked.

In view of the above circumstances, an object of the present invention is to provide a technology for blocking a signal having an inappropriate wavelength.

### Solution to Problem

An aspect of the present invention is a communication system including: a multiplexer that multiplexes a signal input from a user terminal; a splitter that splits a signal addressed to a user terminal from a multiplexed signal; and a blocker of at least one of a multiplexing blocker that blocks a wavelength component other than a wavelength set to a user terminal in a signal output from a user terminal before or after multiplexing by the multiplexer is performed, or a splitting blocker that blocks a wavelength component other than a wavelength set to a user terminal in a signal addressed to a user terminal split by the splitter after or before splitting by the splitter is performed.

An aspect of the present invention is a control method of a communication system including: a multiplexer that multiplexes a signal input from a user terminal; and a splitter that splits a signal addressed to a user terminal from a multiplexed signal, the control method including: a step of at least one of a multiplexing blocking step of blocking a wavelength component other than a wavelength set to a user terminal in a signal output from a user terminal before or after multiplexing by the multiplexer is performed, or a splitting blocking step of blocking a wavelength component other than a wavelength set to a user terminal in a signal addressed to a user terminal split by the splitter after or before splitting by the splitter is performed.

### Advantageous Effects of Invention

According to the present invention, it is possible to provide a technology for reducing conduction of a signal having an inappropriate wavelength.

### BRIEF DESCRIPTION OF DRAWINGS

FIG. 1 is a configuration diagram illustrating a communication system according to the present embodiment.

FIG. 2 is a diagram illustrating a configuration example of a Ph-GW according to a first embodiment.

FIG. 3 is a diagram illustrating a configuration example of a Ph-GW according to a second embodiment.

FIG. 4 is a diagram illustrating a configuration example of a Ph-GW according to a third embodiment.

FIG. 5 is a diagram illustrating an example of set wavelengths and a wavelength therebetween.

FIG. 6 is a diagram illustrating a configuration example of a Ph-GW according to a fourth embodiment.

FIG. 7 is a flowchart illustrating a flow of processing common in each embodiment.

FIG. 8 is a diagram illustrating user devices at an APN.

FIG. 9 is a diagram illustrating Configuration Example 1 of a ROADM.

FIG. 10 is a diagram illustrating Configuration Example 2 of the ROADM.

FIG. 11 is a diagram illustrating Configuration Example 3 of the ROADM.

FIG. 12 is a diagram illustrating Configuration Example 4 of the ROADM.

### DESCRIPTION OF EMBODIMENTS

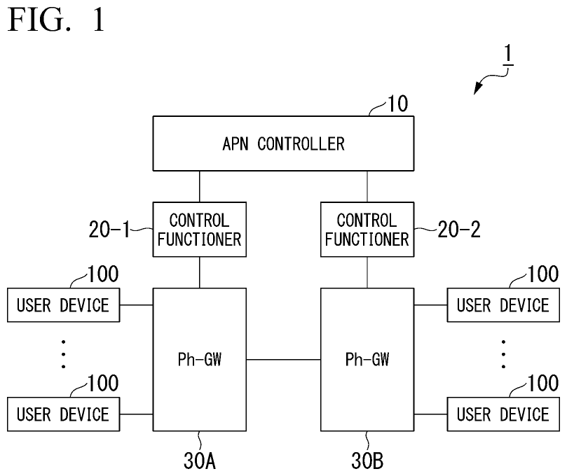

FIG. 1 is a configuration diagram illustrating a communication system 1 according to the present embodiment. The communication system 1 includes an all-photonics network (APN) controller (also referred to as “APNC”) 10, control functioners 20-1 and 20-2, Ph-GWs 30-1 and 30-2, and user devices 100. In a case where each of the control functioners 20-1 and 20-2 is not distinguished, they are referred to as control functioner 20. The control functioner 20 controls the Ph-GW autonomously or according to an instruction or the like from the APNC 10, and sets a route of the Ph-GW. The Ph-GW controls user devices autonomously or according to an instruction or the like from the control functioner 20 or the APNC 10. For example, the transmission/reception wavelength is controlled. The control functioner 20 or the APNC 10 may directly control the user devices 100. In that case, the control functioner 20 or the APNC 10 may include an AMCC transceiver in a case where an AMCC is used as the control signal, for example, in order to transmit and receive a control signal to and from the user devices 100. In a case where each of the Ph-GWs 30-1 and 30-2 is not distinguished, they are referred to as Ph-GW 30.

Each of the user devices 100 is connected to the Ph-GW 30. Each of the user devices 100 exchanges information with the Ph-GW 30 via the control functioner 20, for example. At this time, the control functioner may be a part of the Ph-GW 30.

The Ph-GW 30 is connected to the control functioner 20. Note that, in a case where the control functioner 20 is a part of the Ph-GW 30, each of the user devices 100 may be connected to the Ph-GW 30 so as to be able to communicate also with the control functioner 20. In the configuration illustrated in FIG. 1, each of the user devices 100 sets a wavelength or the like used for communication by exchanging a control signal for performing management control of communication with the Ph-GW using a control signal, for example, a control signal on the AMCC at the start of communication. At the time of setting, the Ph-GW 30 sets a route through which the control functioner 20 and each of the user devices 100 can communicate. After the setting is completed, the Ph-GW 30 sets a route through which each of the user devices 100 can communicate with an opposing communication device, for example, another user device.

The Ph-GW 30 mainly includes five functions. The first is a wavelength control/monitoring function of designating and controlling which wavelength is used by each of the user devices 100 and monitoring the wavelength of a signal. The second is a passing/stopping function of passing a signal in accordance with opening of a path and stopping an unnecessary signal. The third is a aggregation/disaggregation function of a function of aggregating optical signals having wavelengths set to the respective user devices and transferring the optical signals to a relay network, and disaggregating optical signals transferred from the relay network for each of the wavelengths. The fourth is a turning function of enabling turning back at the Ph-GW 30 to which an optical signal is input. The fifth is an extraction/insertion function for performing reproduction, relay, and electrical processing.

The Ph-GW 30 can be configured using various components. Hereinafter, together with description of each configuration example, embodiments for blocking a wavelength component of an unset wavelength in the configuration example will be described.

### First Embodiment

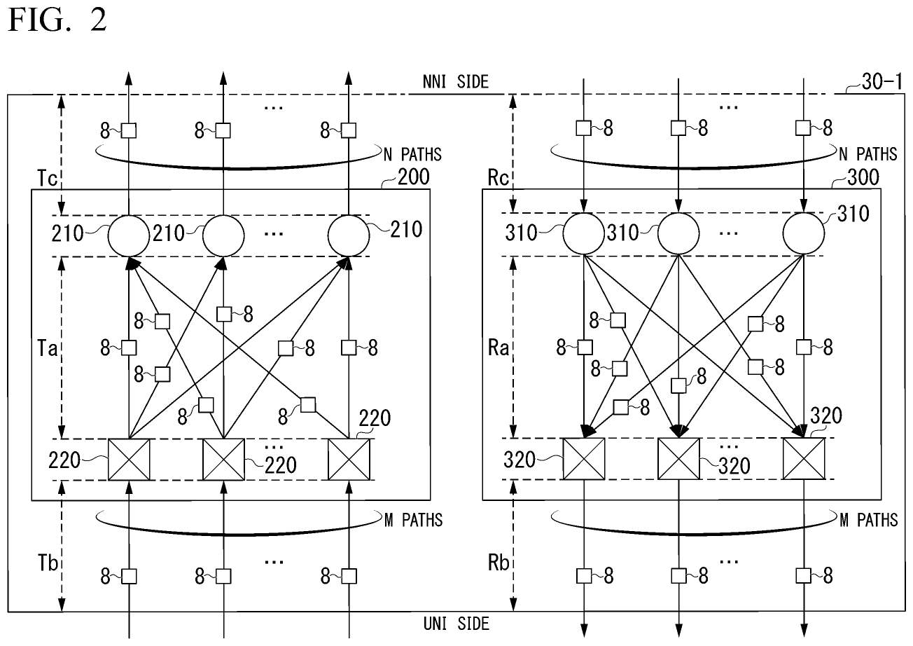

FIG. 2 is a diagram illustrating a configuration example of the Ph-GW 30-1 according to a first embodiment. In the first embodiment, a Ph-GW to which Configuration Example 2 described in the conventional technology is applied will be described. The Ph-GW 30-1 includes, for example, two MCSs 200 and 300 in an uplink direction and a downlink direction, and tunable filters 8. The tunable filters 8 are examples of a blocker. Each of the tunable filters 8 transmits only an appropriate wavelength so as to block a wavelength component whose transmission is not allowed.

The MCS 200 includes M 1*N optical switches 220 and N M*1 couplers/splitters 210. Each of the 1*N optical switches 220 receives as input a signal on one path from the UNI side input.

Each of the 1*N optical switches 220 outputs the signal input from the UNI side to any of the M*1 couplers/splitters 210.

Each of the M*1 couplers/splitters 210 multiplexes signals input from the 1*N optical switches 220 and outputs the multiplexed signals to one path on the NNI side. The 1*M couplers/splitters 210 are power splitters or optical couplers having no wavelength dependency, and are parts of examples of a multiplexer.

The MCS 300 includes N 1*M couplers/splitters 310 and M N*1 optical switches 320. Each of the 1*M couplers/splitters 310 receives as input a signal on one path from the NNI side. Each of the 1*M couplers/splitters 310 splits the signal input from the NNI side and outputs the signals to the N*1 optical switches 320. Each of the N*1 optical switches 320 selects a signal from the 1*M couplers/splitters 310 according to the input port, and outputs the signal to one path on the UNI side. The 1*M couplers/splitters 310 are parts of examples of a splitter.

In the above configuration, the tunable filters 8 can be included in sections Ta and Tb that are sections in which multiplexing by the M*1 couplers/splitters 210 that form the multiplexer is not yet performed. The tunable filters 8 can be included in sections Ra and Rb that are sections in which splitting by the 1*M couplers/splitters 310 that form the splitter has already been performed. The tunable filters 8 can be included in a section Tc that is a section in which multiplexing by the M*1 couplers/splitters 210 has already been performed. The tunable filters 8 can be included in a section Rc that is a section in which splitting by the 1*M couplers/splitters 310 is not yet performed. Note that, in a case where blocking is performed after splitting, a signal mixed with a signal having a wavelength other than a set wavelength may be first blocked, and a signal outputting a wavelength other than a set wavelength may be blocked.

On the input side, the tunable filters 8 are only required to be included in any one of the sections Ta, Tb, and Tc. On the output side, the tunable filters 8 are only required to be included in any one of the sections Ra, Rb, and Rc.

Note that the section Ta in the first embodiment is a section from the 1*N optical switches 220 to the M*1 couplers/splitters 210. The section Tb in the first embodiment is a section from the user terminals 100 to the 1*N optical switches 220. The section Tc in the first embodiment is a section from the M*1 couplers/splitters 210 to the NNI side. The section Ra in the first embodiment is a section from the 1*M couplers/splitters 310 to the N*1 optical switches 320. The section Rb in the first embodiment is a section from the N*1 optical switches 320 to the user terminals 100. The section Rc in the first embodiment is a section from the NNI side to the 1*M couplers/splitters 310.

In a case where the tunable filters 8 are included in the section Ta or the section Ra, N M*1 couplers/splitters 210 and N 1*M couplers/splitters 310 are included, and M 1*N optical switches 220 and M N*1 optical switches 320 are included, and thus M*N tunable filters 8 are included. In this case, although the number of tunable filters increases, setting can be performed for each of M*N routes, and thus the tunable filters can be set more individually. On the other hand, in a case where the tunable filters 8 are included in the section Tb or the section Rb, M tunable filters 8 are included. In a case where the tunable filters 8 are included in the section Tc or the section Rc, N tunable filters 8 are included. In a case where a plurality of wavelengths is transmitted by wavelength division multiplexing (WDM) in the section Tc and the section Rc, tunable filters capable of selectively transmitting a plurality of corresponding proper wavelengths are required. In a case where a proper wavelength of an optical signal input and output from the UNI can be a single wavelength, tunable filters capable of selectively transmitting at least a single wavelength can be used in the sections Ta, Tb, Ra, and Rb.

In any case, for each of the user terminals 100, the tunable filters 8 can filter a signal input by the user terminal 100. An APN controller 10 notifies the tunable filters 8 of wavelengths set to user terminals 100, so that the tunable filters 8 are adjusted to filters that block wavelength components other than the set wavelengths.

Note that, instead of blocking wavelength components by the tunable filters 8, the 1*N optical switches 220 and the N*1optical switches 320 may block wavelength components other than the wavelengths set to the user terminals. Also in this case, the APN controller 10 notifies the 1*N optical switches 220 and the N*1 optical switches 320 of the wavelengths set to the user terminals 100. As a result, the 1*N optical switches 220 and the N*1 optical switches 320 can block wavelength components other than the set wavelengths. In this case, a wavelength monitor may be newly included, wavelengths may be detected by the wavelength monitor, and wavelength components other than the wavelengths set to the user terminals may be blocked by the 1*N optical switches 220 and the N*1 optical switches 320.

In the first embodiment, the tunable filters 8 may be included only on one of the side on which signals are input from the user terminals 100 and the side on which signals are output to the user terminals 100. In a case where the tunable filters 8 are included in the sections Ta and Tb on the side on which signals are input from the user terminals 100, wavelength components other than the set wavelengths, such as wavelength components of signals erroneously generated due to failures of the user terminals 100, can be filtered. In a case where the tunable filters 8 are included in the sections Ra and Rb on the side on which signals are output to the user terminals 100, wavelength components other than the set wavelengths, such as wavelength components of signals erroneously generated due to failures of devices, can be filtered. In a case where the tunable filters 8 are included on the input side, input other than the wavelength components allowed for the users can be blocked, and in a case where the tunable filters 8 are included on the output side, output other than the wavelength components allowed for the network can be blocked, and the tunable filters 8 on both sides are included for both sides of blocking, and the tunable filters 8 on one side are included for corresponding one side of blocking.

### Second Embodiment

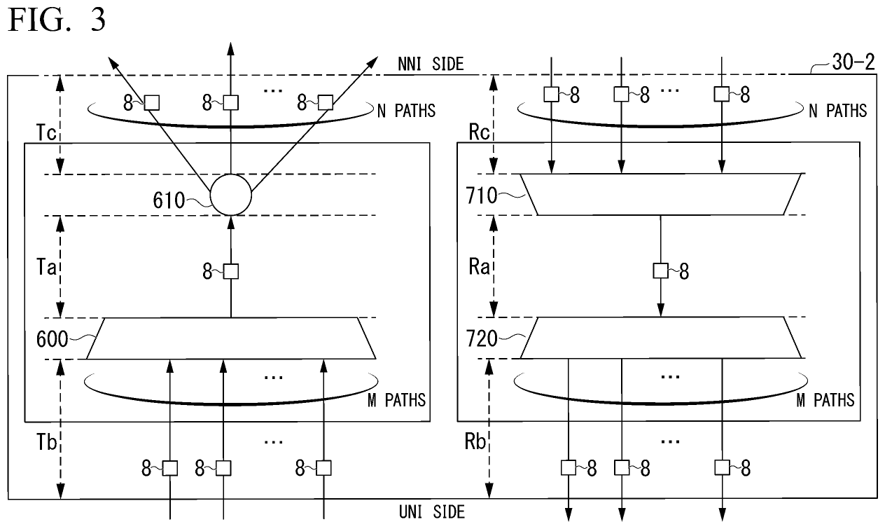

FIG. 3 is a diagram illustrating a configuration example of a Ph-GW 30-2 according to a second embodiment. In the second embodiment, a Ph-GW to which Configuration Example 1 described in the conventional technology is applied will be described. The Ph-GW 30-2 includes an M*1 WSS 600 having an M*1 configuration, a 1*N coupler/splitter 610 having a 1*N configuration, an N*1 WSS 710 having an N*1 configuration, and a 1*M WSS 720 having a 1*M configuration.

The M*1 WSS 600 receives as input signals on M paths from the UNI side. The M*1 WSS 600 multiplexes the signals input from the UNI side according to the combination of an input port and a wavelength (selects and multiplexes signals having predetermined wavelengths set for the respective UNIs), and outputs the signals to the 1*N coupler/splitter 610. The 1*N coupler/splitter 610 splits the signals input from the M*1 WSS 600 for N paths and outputs the signals to the N paths on the NNI side. The M*1 WSS 600 is a part of an example of the multiplexer.

The N*1 WSS 710 receives as input signals on N paths from the NNI side. The N*1 WSS 710 multiplexes the signals input from the NNI side according to the combination of an input port and a wavelength (selects and multiplexes signals having predetermined wavelengths set for respective NNIs), and outputs the signals to the 1*M WSS 720. The 1*M WSS 720 outputs the signals from the N*1 WSS 710 to the M paths on the UNI side according to the wavelength (performs separation for each wavelength, and outputs signals having predetermined wavelengths set for respective UNIs to the UNI side). The 1*M WSS 720 is a part of an example of the splitter.

In the above configuration, tunable filters 8 can be included in a section Tb that is a section in which multiplexing by the M*1 WSS 600 is not yet performed. The tunable filters 8 can be included in sections Ta and Tc that are sections in which multiplexing by the M*1 WSS 600 has already been performed. The tunable filters 8 can be included in a section Rb that is a section in which separation by the 1*M WSS 720 has already been performed. The tunable filters 8 can be included in sections Ra and Rc that are sections in which separation by the 1*M WSS 720 is not yet performed. In a case where blocking is performed after separating, a signal mixed with a signal having a wavelength other than a set wavelength may be first blocked, and a signal outputting a wavelength other than a set wavelength may be blocked.

Note that the section Ta in the second embodiment is a section from the M*1 WSS 600 to the 1*N coupler/splitter 610. The section Tb in the second embodiment is a section from the user terminals 100 to the M*1 WSS 600. The section Tc in the second embodiment is a section from the 1*N coupler/splitter 610 to the NNI side. The section Rb in the second embodiment is a section from the 1*M WSS 720 to the user terminals 100. The section Ra in the second embodiment is a section from the N*1 WSS 710 to the 1*M WSS 720. The section Rc in the second embodiment is a section from the NNI side to the N*1 WSS 710.

In a case where the tunable filters 8 are included in the section Tb or the section Rb, M tunable filters 8 are included. In a case where the tunable filters 8 are included in the section Tc or the section Rc, N tunable filters 8 are included. In a case where the tunable filter 8 is included in the section Ta or the section Ra, one tunable filter 8 is included. In a case where a plurality of wavelengths is transmitted by wavelength division multiplexing in the sections Ta, Tc, Rc, and Ra, tunable filters capable of selectively transmitting a plurality of corresponding proper wavelengths are required. In a case where a proper wavelength of an optical signal input and output from the UNI can be a single wavelength, tunable filters capable of selectively transmitting at least a single wavelength can be used in the sections Tb and Rb.

In any case, for each of the user terminals 100, the tunable filters 8 can block a signal input by the user terminal 100. An APN controller 10 notifies the tunable filters 8 of wavelengths set to user terminals 100, so that the tunable filters 8 are adjusted to filters that block wavelength components other than the set wavelengths.

In the second embodiment, the tunable filters 8 may be included only on one of the side on which signals are input from the user terminals 100 and the side on which signals are output to the user terminals 100. In a case where the tunable filters 8 are included in the section Tb on the side on which signals are input from the user terminals 100, wavelength components other than the set wavelengths, such as wavelength components of signals erroneously generated due to failures of the user terminals 100, can be filtered. In a case where the tunable filters 8 are included in the section Rb on the side on which signals are output to the user terminals 100, wavelength components other than the set wavelengths, such as wavelength components of signals erroneously generated due to failures of devices, can be filtered. In a case where the tunable filters 8 are included on the input side, input other than the wavelength components allowed for the users can be blocked, and in a case where the tunable filters 8 are included on the output side, output other than the wavelength components allowed for the network can be blocked, and the tunable filters 8 on both sides are included for both sides of blocking, and the tunable filters 8 on one side are included for corresponding one side of blocking.

### Third Embodiment

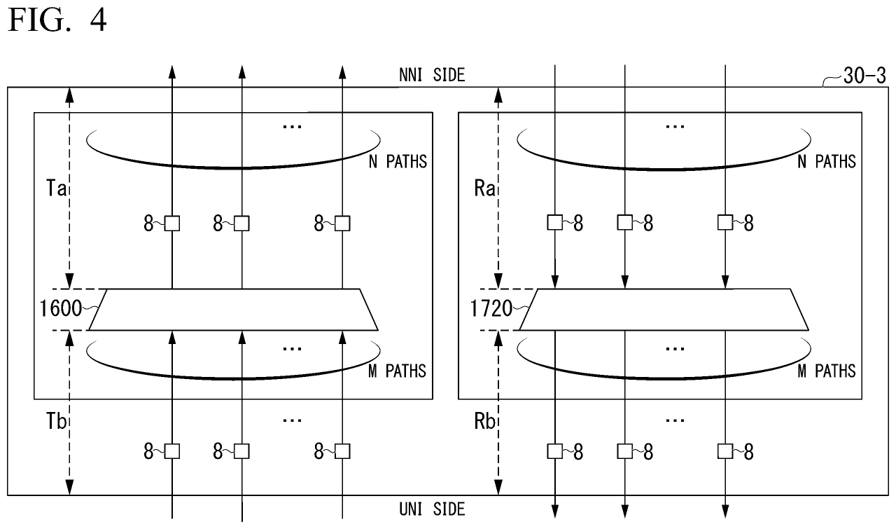

FIG. 4 is a diagram illustrating a configuration example of a Ph-GW 30-3 according to a third embodiment. In the third embodiment, a Ph-GW to which Configuration Example 3 or Configuration Example 5 described in the conventional technology are applied will be described. The Ph-GW 30-3 includes an M*N WSS 1600 and an N*M WSS 1720.

The M*N WSS 1600 receives as input signals on M paths from the UNI side. The M*N WSS 1600 outputs the signals input from the UNI side to any of N paths on the NNI side according to the combination of a port and a wavelength. The M*N WSS 1600 is an example of the multiplexer.

The N*M WSS 1720 receives as input signals on the N paths from the NNI side. The N*M WSS 1720 outputs the signals input from the NNI side to any of M paths on the UNI side according to the combination of an input port and a wavelength. The N*M WSS 1720 is an example of the splitter.

In the above configuration, tunable filters 8 can be included in a section Tb that is a section in which multiplexing by the M*N WSS 1600 is not yet performed. The tunable filters 8 can be included in a section Ta that is a section in which multiplexing by the M*N WSS 1600 has already been performed.

The tunable filters 8 can be included in a section Ra that is a section from the NNI side to the N*M WSS 1720 or a section Rb that is a section in which separation by the N*M WSS 1720 has already been performed. In a case where blocking is performed after separating, a signal mixed with a signal having a wavelength other than a set wavelength may be first blocked, and a signal outputting a wavelength other than a set wavelength may be blocked.

Note that the section Tb in the third embodiment is a section from the user terminals 100 to the M*N WSS 1600. The section Ta in the third embodiment is a section from the M*N WSS 1600 to the NNI side. The section Ra in the third embodiment is a section from the NNI side to the N*M WSS 1720. The section Rb in the third embodiment is a section from the N*M WSS 1720 to the user terminals 100.

In a case where the tunable filters 8 are included in the section Tb or the section Rb, M tunable filters 8 are included. In a case where the tunable filters 8 are included in the section Ta or the section Ra, N tunable filters 8 are included. In a case where a plurality of wavelengths is transmitted by wavelength division multiplexing in the sections Ta and Ra, tunable filters capable of selectively transmitting a plurality of corresponding proper wavelengths are required. In a case where a proper wavelength of an optical signal input and output from the UNI can be a single wavelength, tunable filters capable of selectively transmitting at least a single wavelength can be used in the sections Tb and Rb.

In any case, for each of the user terminals 100, the tunable filters 8 can filter a signal input by the user terminal 100. An APN controller 10 notifies the tunable filters 8 of wavelengths set to user terminals 100, so that the tunable filters 8 are adjusted to filters that block wavelength components other than the set wavelengths.

In the third embodiment, the tunable filters 8 may be included only on one of the side on which signals are input from the user terminals 100 and the side on which signals are output to the user terminals 100. In a case where the tunable filters 8 are included in the section Tb on the side on which signals are input from the user terminals 100, wavelength components other than the Set wavelengths, such as wavelength components of signals erroneously generated due to failures of the user terminals 100, can be filtered. In a case where the tunable filters 8 are included in the section Ra or the section Rb on the side on which signals are output to the user terminals 100, wavelength components other than the set wavelengths, such as wavelength components of signals erroneously generated due to failures of devices, can be filtered. In a case where the tunable filters 8 are included on the input side, input other than the wavelength components allowed for the users can be blocked, and in a case where the tunable filters 8 are included on the output side, output other than the wavelength components allowed for the network can be blocked, and the tunable filters 8 on both sides are included for both sides of blocking, and the tunable filters 8 on one side are included for corresponding one side of blocking.

### Fourth Embodiment

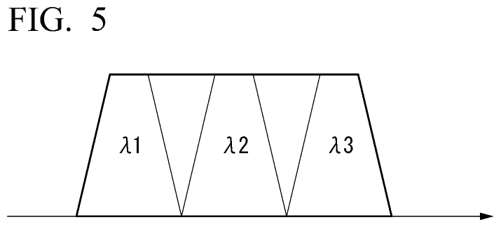

In a fourth embodiment, in the first to third embodiments, in a case where a plurality of non-adjacent wavelengths is set to the subordinate user terminals 100, a wavelength between the set wavelengths is an inappropriate wavelength. FIG. 5 is a diagram illustrating an example of set wavelengths and a wavelength therebetween. In FIG. 5, in a case where wavelengths λ1 and λ3 are set wavelengths, λ2 therebetween is an inappropriate wavelength. In such a case, a wavelength filter that blocks an improper wavelength may be included. The wavelength filter may select an odd wavelength or an even wavelength by an interleaver. Alternatively, only one of the wavelengths λ1, λ2, and λ3 may be transmitted, or only two of the wavelengths λ1, λ2, and λ3 may be transmitted by setting.

### Fifth Embodiment

In a case of the wavelength arrangement as in the fourth embodiment described above, it is desirable to separately include a wavelength filter even in the form using Configuration Example 4 described in the conventional technology. Therefore, a form using Configuration Example 4 will be described as a fifth embodiment.

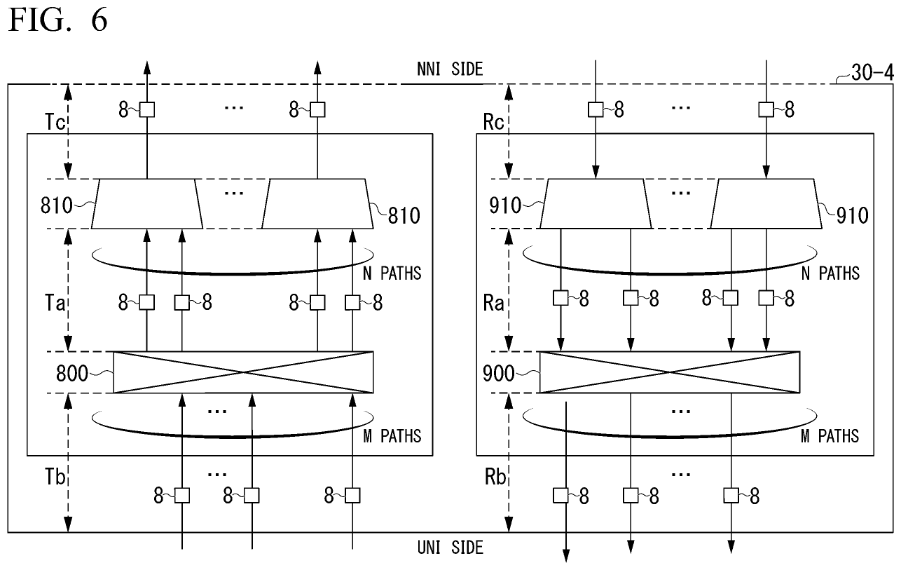

FIG. 6 is a diagram illustrating a configuration example of a Ph-GW 30-4 according to a fifth embodiment. The Ph-GW 30-4 includes an optical switch 800, AWGs 810, AWGs 910, and an optical switch 900. The UNI sides of the optical switches are M or more. When the AWGs are 1*K, the UNI sides of the optical switches are N*K or more. When the optical switches are asymmetric types, M*(N*K) optical switches may be used. When the optical switches are symmetric types, optical switches having larger scales of either M*M optical switches or N*K optical switches are required to be adopted.

The optical switch 800 receives as input signals on M paths from the UNI side. The optical switch 800 outputs the signals input from the UNI side to any port of any AWG 810 according to the input port. Each of the AWGs 810 multiplexes the signals input from the optical switch 800 according to the combination of an input port and a wavelength, and outputs the signals to the NNI side. The AWGs 810 are parts of examples of the multiplexer.

Each of the AWGs 910 outputs a signal input from the NNI side to any of ports of the optical switch 900 according to the combination of an input port and a wavelength. The optical switch 900 outputs signals input from the AWGs 910 to paths on the UNI side according to the input port. The AWGs 910 are parts of examples of the splitter.

In the above configuration, tunable filters 8 can be included in sections Ta and Tb that are sections in which multiplexing by the AWGs 810 is not yet performed. The tunable filters 8 can be included in a section Tc that is a section in which multiplexing by the AWGs 810 has already been performed. The tunable filters 8 can be included in sections Ra and Rb that are sections in which separation by the AWGs 910 has already been performed. The tunable filters 8 can be included in a section Rc that is a section in which separation by the AWGs 910 is not yet performed. In a case where blocking is performed after separating, a signal mixed with a signal having a wavelength other than a set wavelength may be first blocked, and a signal outputting a wavelength other than a set wavelength may be blocked.

Note that the section Ta in the fifth embodiment is a section from the optical switch 800 to the AWGs 810. The section Tb in the fifth embodiment is a section from the user terminals 100 to the optical switch 800. The section Tc in the fifth embodiment is a section from the AWGs 810 to the NNI side. The section Ra in the fifth embodiment is a section from the AWGs 910 to the optical switch 900. The section Rb in the fifth embodiment is a section from the optical switch 900 to the user terminals 100. The section Rc in the fifth embodiment is a section from the NNI side to the AWGs 910.

In a case where the tunable filters 8 are included in the section Ta or the section Ra, M or N*K tunable filters 8 are included. On the other hand, in a case where the tunable filters 8 are included in the section Tb or the section Rb, M tunable filters 8 are included. In a case where the tunable filters 8 are included in the section To or the section Rc, N tunable filters 8 are included. In a case where a plurality of wavelengths is transmitted by wavelength division multiplexing in the section Tc and the section Rc, tunable filters capable of selectively transmitting a plurality of corresponding proper wavelengths are required. In a case where a proper wavelength of an optical signal input and output from the UNI can be a single wavelength, tunable filters capable of selectively transmitting at least a single wavelength can be used in the sections Ta, Tb, Ra, and Rb.

In any case, for each of the user terminals 100, the tunable filters 8 can filter a signal input by the user terminal 100. An APN controller 10 notifies the tunable filters 8 of wavelengths set to user terminals 100, so that the tunable filters 8 are adjusted to filters that block wavelength components other than the set wavelengths.

Note that, instead of blocking by the tunable filters 8, the optical switch 800 and the optical switch 900 may block wavelength components other than the wavelengths set to the user terminals.

Also in this case, the APN controller 10 notifies the optical switch 800 and the optical switch 900 of the wavelengths set to the user terminals 100. As a result, the optical switch 800 and the optical switch 900 can block wavelength components other than the set wavelengths. Note that the AWGs 810 and the AWGs 910 may be other than AWGs as long as demultiplexing can be performed for each wavelength or a plurality of wavelengths can be multiplexed.

In the fifth embodiment, the tunable filters 8 may be included only on one of the side on which signals are input from the user terminals 100 and the side on which signals are output to the user terminals 100. In a case where the tunable filters 8 are included in the sections Ta and Tb on the side on which signals are input from the user terminals 100, wavelength components other than the set wavelengths, such as wavelength components of signals erroneously generated due to failures of the user terminals 100, can be filtered. In a case where the tunable filters 8 are included in the sections Ra and Rb on the side on which signals are output to the user terminals 100, wavelength components other than the set wavelengths, such as wavelength components of signals erroneously generated due to failures of devices, can be filtered. In a case where the tunable filters 8 are included on the input side, input other than the wavelength components allowed for the users can be blocked, and in a case where the tunable filters 8 are included on the output side, output other than the wavelength components allowed for the network can be blocked, and the tunable filters 8 on both sides are included for both sides of blocking, and the tunable filters 8 on one side are included for corresponding one side of blocking.

Note that wavelength filters may be included between the AWGs 810 and the NNI side or between the NNI side and the AWGs 910, but since the shapes of the wavelength filters become complicated, it is desirable to include the wavelength filters in the sections Ta, Tb, Ra, and Rb as described above. In a case where the wavelength filters are included in the optical switch 800 and the optical switch 900, the inclusion may be implemented by cross-linking connection in which output of a predetermined optical switch from an input port of the optical switch is temporarily input to the wavelength filter, and output of the wavelength filter is input to the optical switch again from another input port and is output from an output port of the predetermined optical switch.

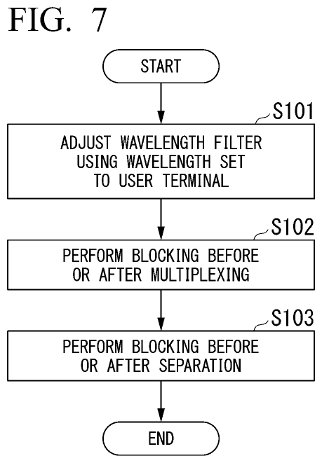

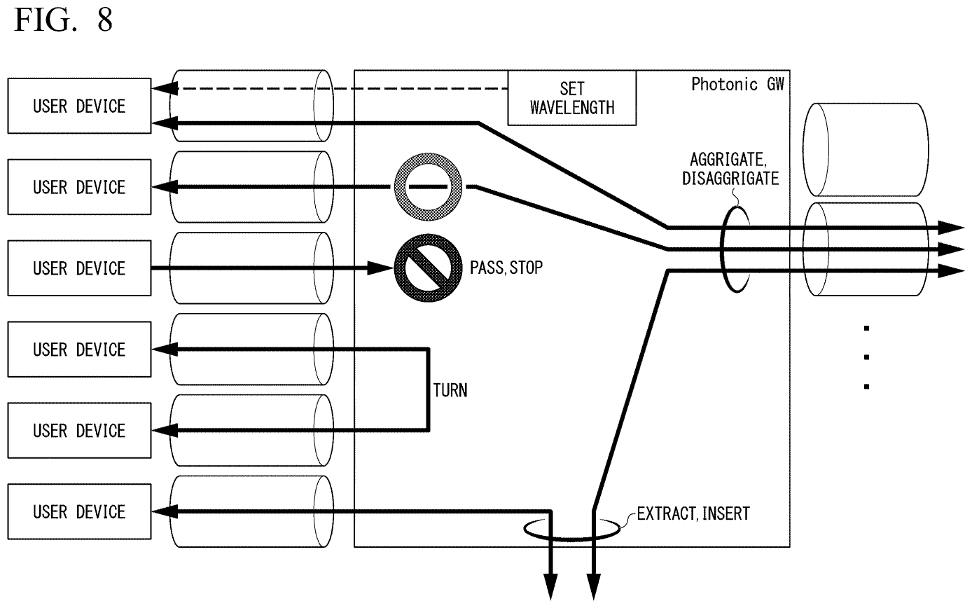

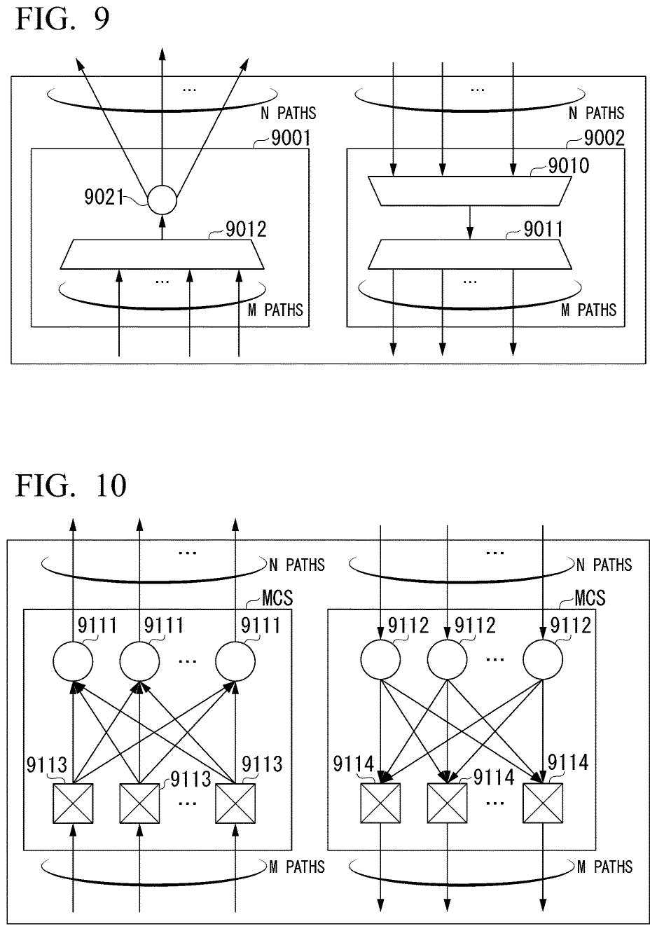

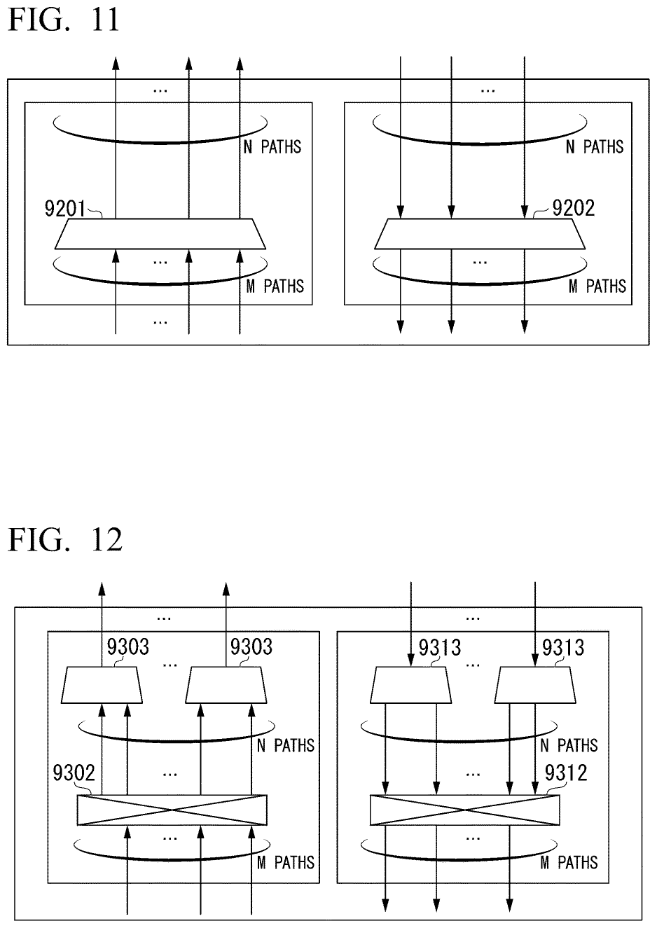

FIG. 7 is a flowchart illustrating a flow of processing common in each embodiment described above. In FIG. 7, a wavelength filter 1000 is adjusted such that wavelength components other than a wavelength set to a user terminal 100 is blocked (step S101). As a result, according to the configuration of the Ph-GW 30 described in each embodiment, wavelength components other than the wavelength set to the user terminal 100 are blocked before multiplexing (step S102) and blocked after separation (step S103). Regarding step S102 and step S103, step S102 may be executed after step S103. Only one of step S102 and step S103 may be executed.

As described above, in Configuration Example 2 in which multiplexing and separation are performed by couplers/splitters having no wavelength selectivity and Configuration Examples 1, 3, and 5 each in which WSSs that perform multiplexing and separation toward a path according to the wavelength are used, it is possible to, in a case where a user terminal inputs a wavelength other than set wavelengths, reduce a communication failure of user terminals that share a transmission path or the like by performing blocking by a wavelength filter before multiplexing with another signal is performed. Furthermore, unintended input to a user terminal is reduced by blocking being performed using a wavelength filter before output to the NNI side is performed. Note that, in a case where an improper wavelength can be blocked at the input stage and a failure in the Ph-GW 30 can be ignored, a blocker may be included only at the input stage.

By including a tunable filter for a signal input to the UNI side, it is possible to prevent communication content from being erroneously leaked to a person other than the communication partner due to a failure or the like in the Ph-GW 30. Furthermore, by also including a tunable filter for a signal output to the NNI side in addition to a tunable filter for a signal input to the UNI side, it is possible, not only to prevent the leakage, but also to reduce a communication failure of a user terminal using a proper wavelength due to superimposition of an improper wavelength of another user terminal.

In each embodiment described above, instead of the filter 8, a shutter or a switch may block a signal having an inappropriate wavelength.

Although the embodiments of the present invention have been described in detail with reference to the drawings, specific configurations are not limited to the embodiments and include design and the like within the gist of the present invention.

### Industrial Applicability

The present invention is applicable to a communication system that performs communication through an optical fiber transmission line.

### Reference Signs List

30-1, 30-2, 30-2, 30-4 . . . Ph-GW
210, 310 . . . 1*M coupler/splitter
220, 320 . . . N*1 optical switch
600, 720 . . . M*1 WSS
710 . . . N*1 WSS
1600 . . . M*N WSS
1720 . . . N*M WSS
800 . . . Optical switch
900 . . . Optical switch
900, 810, 910 . . . AWG
8 . . . Tunable filter

1. A communication system comprising:
a multiplexer that multiplexes a signal input from a user terminal;
a splitter that splits a signal addressed to a user terminal from a multiplexed signal; and
a blocker of at least one of a multiplexing blocker that blocks a wavelength component other than a wavelength set to a user terminal in a signal input from a user terminal before or after multiplexing by the multiplexer is performed, or a splitting blocker that blocks a wavelength component other than a wavelength set to a user terminal in a signal addressed to a user terminal split by the splitter after or before splitting by the splitter is performed.

2. The communication system according to claim 1,
wherein in a case where a switch is included between the multiplexer and a user terminal, the multiplexing blocker is included between the multiplexer and the switch or between the switch and a user terminal.

3. The communication system according to claim 1,
wherein in a case where a switch is included between the splitter and a user terminal, the splitting blocker is included between the splitter and the switch or between the switch and a user terminal.

4. The communication system according to claim 1,
wherein the multiplexing blocker is a switch included between the multiplexer and a user terminal, and the switch blocks a wavelength component other than a wavelength set to a user terminal in a signal input from a user terminal before multiplexing by the multiplexer is performed.

5. The communication system according to claim 1,
wherein the splitting blocker is a switch between the splitter and a user terminal, and the switch blocks a wavelength component other than a wavelength set to a user terminal in a signal addressed to a user terminal split by the splitter after splitting by the splitter is performed.

6. The communication system according to claim 1, wherein the blocker is a wavelength filter.

7. A control method of a communication system including: a multiplexer that multiplexes a signal input from a user terminal; and a splitter that splits a signal addressed to a user terminal from a multiplexed signal, the control method comprising:
at least one of blocking a wavelength component other than a wavelength set to a user terminal in a signal input from a user terminal before or after multiplexing by the multiplexer is performed, or blocking a wavelength component other than a wavelength set to a user terminal in a signal addressed to a user terminal split by the splitter after or before splitting by the splitter is performed.

8. The communication system according to claim 2,
wherein in a case where a switch is included between the splitter and a user terminal, the splitting blocker is included between the splitter and the switch or between the switch and a user terminal.

9. The communication system according to claim 4,
wherein the splitting blocker is a switch between the splitter and a user terminal, and the switch blocks a wavelength component other than a wavelength set to a user terminal in a signal addressed to a user terminal split by the splitter after splitting by the splitter is performed.
